(19) United States
(12) Patent Application Publication
(10) Pub. No.: US 2022/0373988 A1
(43) Pub. Date: Nov. 24, 2022

(54) Method and Device for Generating a Building Automation Project

(71) Applicant: Siemens Schweiz AG, Zürich (CH)

(72) Inventors: Birgit Huber, Zug (CH); Heinrich Kränzlin-Meier, Feusisberg (CH); Dantong Yang, Zug (CH); Benedikt Schumacher, Wetzikon (CH)

(73) Assignee: Siemens Schweiz AG, Zürich (CH)

(21) Appl. No.: 17/762,200

(22) PCT Filed: Aug. 14, 2020
(86) PCT No.: PCT/EP2020/072839

§ 371 Date: Mar. 21, 2022

(30) Foreign Application Priority Data
Sep. 20, 2019 (EP) 19198514.2

(51) Int. Cl. G05B 19/042

(52) U.S. Cl. CPC G05B 19/042; G05B 2219/25011

(57) ABSTRACT

Various embodiments of the teachings herein include a computer-implemented method for generating a building automation project of a building automation system. The method may include: receiving structural information regarding building equipment; generating a semantic model of the building automation system, including automatically extracting equipment information from the structural information; extending the semantic model of the building automation system by providing application information; and generating, based on the equipment information and application information of the extended semantic model, a building automation project adapted for loading on a building automation device.

### CROSS-REFERENCE TO RELATED APPLICATIONS

This application is a U.S. National Stage Application of International Application No. PCT/EP2020/072839 filed Aug. 14, 2020, which designates the United States of America, and claims priority to EP Application No. 19198514.2 filed Sep. 20, 2019, the contents of which are hereby incorporated by reference in their entirety.

### TECHNICAL FIELD

The present disclosure relates to building automation. Various embodiments of the teachings herein include computer-implemented methods for generating a building automation project of a building automation system and/or corresponding devices for generating a building automation project of a building automation system.

### BACKGROUND

Amongst the on-going efforts to reduce detrimental effects on the environment, so called “green building” tries to minimize the environmental impact and tries to increase the resource-efficiency throughout the entire life-cycle of the building, including planning, design and construction of the building, as well as operation, maintenance and the like. Green buildings typically accommodate building automation systems, BAS, which can manage resources in a very efficient way.

Modern building automation systems aim to provide a completely autonomous control of electronic or mechanical devices of a facility or building. Electronic and mechanical devices to be controlled by the automation system comprise heating, ventilation and air conditioning, HVAC, equipment which provide thermal comfort and good air quality. HVAC equipment can comprise temperature or humidity sensors distributed in the rooms of the building or facility which provide sensor data. Based on the sensor data, control systems control field devices, such as valves, heaters, ventilation systems, air conditioner, air filter and the like. In addition to HVAC equipment, electronic or mechanical devices of the facility or building to be controlled may comprise security systems, fire alarm systems, lighting systems or various mechanical components, e.g. blinds.

The building automation process typically includes a planning stage where input is received from various different sources. The input may include architectural drawings, plant diagrams, and/or functional specifications in different file formats. Based on these resources, a preliminary technical concept is created. At the next stage, the preliminary technical concept is processed and a detailed design is created, comprising devices (such as field devices, controllers and IoT devices) network topology, electrical drawings, applications and detailed technical drawings. The detailed concept is then implemented and configured using software tools. A building automation project is created.

Accordingly, the processes from the initial input up to the final building automation project is relatively complex and involves interplay and coordination of different experts with different backgrounds. At each stage, information may be present in different file formats, often without any consistent or uniform description or documentation. For example, changes or modifications may require tedious adaptations at each stage. Moreover, previous work and experiences can typically not be sufficiently taken into account for other projects. In other words, for each new project, all tasks have to be started over from scratch, which requires lots of work, time and resources.

### SUMMARY

The teachings of the present disclosure include a simpler and generally applicable way to provide building automation projects. As an example, some embodiments include a computer-implemented method for generating a building automation project (7) of a building automation system, BAS, comprising the steps: receiving (S1), via an interface (11), structural information (31, 32, 33, 34, 35) regarding building equipment; generating (S2) a semantic model (5) of the building automation system, comprising the step of automatically extracting equipment information from the structural information (31, 32, 33, 34, 35) regarding the building equipment; extending (S3) the semantic model (5) of the building automation system by providing application information; and generating (S4), based on the equipment information and application information of the extended semantic model (6) of the building automation system, a building automation project (7) adapted for loading on a building automation device (2).

In some embodiments, the structural information (31, 32, 33, 34, 35) regarding building equipment comprises at least one of: an architectural drawing (31), a heating, ventilation and air conditioning, HVAC, schema (32), an electrical schema (33), technical drawings (34), and a functional specification (35).

In some embodiments, the equipment information of the semantic model (5) of the building automation system comprises at least one of: an architecture semantic model (51) generated based on the architectural drawing (31), an HVAC semantic model (52) generated based on the HVAC schema (32), and an electrical semantic model (53) generated based on the electrical schema (33).

In some embodiments, automatically extracting equipment information from the structural information (31, 32, 33, 34, 35) regarding the building equipment comprises at least one of applying computer vision methods to the structural information (31, 32, 33, 34, 35) regarding the building equipment, and applying data fusion methods to the structural information (31, 32, 33, 34, 35) regarding the building equipment.

In some embodiments, automatically extracting equipment information from the structural information (31, 32, 33, 34, 35) regarding the building equipment comprises specifying a type of building equipment and/or relations of the building equipment.

In some embodiments, providing application information comprises specifying a type of applications corresponding to the building equipment and/or relations of the building equipment.

In some embodiments, extending the semantic model (5) of the building automation system further includes selecting building equipment and/or controller from a database (14).

In some embodiments, extending the semantic model (5) of the building automation system further includes counting data points based on an HVAC semantic model (52) generated based on an HVAC schema (32), and wherein the building equipment and/or controller are selected based on the counted data points.

In some embodiments, extending the semantic model (5) of the building automation system further includes providing protocol type information, and wherein the step of selecting building equipment and/or controller is based on the provided protocol type information.

In some embodiments, extending the semantic model (5) of the building automation system further includes providing a design network topology based on information stored in a database (14).

In some embodiments, generating the building automation project (7) comprises providing at least one of: building structure information, network information, controller information, input/output module information, management station information, field device information, and application information.

In some embodiments, the method further includes loading (S5) the generated building automation project (7) on the building automation device (2) and adjusting building equipment and/or controller by the building automation device (2), using the generated building automation project (7).

As another example, some embodiments include a device for generating a building automation project (7) of a building automation system, BAS, comprising: an interface (11) adapted to receive structural information (31, 32, 33, 34, 35) regarding building equipment; and a computing unit (12) adapted: to generate a semantic model (5) of the building automation system, comprising the step of automatically extracting equipment information from the structural information (31, 32, 33, 34, 35) regarding the building equipment, to extend the semantic model (5) of the building automation system by providing application information, and to generate, based on the equipment information and application information of the extended semantic model (6) of the building automation system, a building automation project (7); wherein the computing unit (12) is further adapted to provide the generated building automation project (7) to a building automation device (2) via the interface (11).

As another example, some embodiments include a computer program product (P) comprising executable program code (PC) configured to, when executed by a computing device, perform one or more of the methods described herein.

As another example, some embodiments include a non-transitory, computer-readable storage medium (M) comprising executable program code (MC) configured to, when executed by a computing device, perform one or more of the methods described herein.

### BRIEF DESCRIPTION OF THE DRAWINGS

The teachings herein are explained in greater detail with reference to exemplary embodiments depicted in the drawings as appended. The accompanying drawings are included to provide a further understanding of the present disclosure and are incorporated in and constitute a part of this specification. The drawings illustrate various embodiments of the teachings herein and together with the description serve to explain the principles of the disclosure. Other embodiments of the teachings herein and many of the intended advantages will be readily appreciated as they become better understood by reference to the following detailed description. Like reference numerals designate corresponding similar parts. It should be understood that method steps are numbered for easier reference, but that said numbering does not necessarily imply steps being performed in that order unless explicitly or implicitly described otherwise. In particular, steps may also be performed in a different order than indicated by their numbering. Some steps may be performed simultaneously or in an overlapping manner.

FIG. 1 schematically shows a block diagram illustrating a device for generating a building automation project of a building automation system incorporating teachings of the present disclosure;

FIG. 2 schematically shows a block diagram illustrating the generation of the building automation project starting from structural information incorporating teachings of the present disclosure;

FIG. 3 schematically shows a flow diagram of a computer-implemented method for generating a building automation project of a building automation system incorporating teachings of the present disclosure;

FIG. 4 schematically illustrates a block diagram illustrating a computer program product incorporating teachings of the present disclosure; and

FIG. 5 schematically illustrates a block diagram illustrating a non-transitory, computer-readable storage medium incorporating teachings of the present disclosure.

### DETAILED DESCRIPTION

In some embodiments, there is a computer-implemented method for generating a building automation project of a building automation system, BAS. An interface receives structural information regarding the building equipment. A computing unit generates a semantic model of the building automation system, comprising the step of automatically extracting equipment information from the structural information regarding the building equipment. The computing unit extends the semantic model of the building automation system by providing application information. The computing unit further generates a building automation project adapted for loading on a building automation device, based on the equipment information and application information of the extended semantic model of the building automation system.

In some embodiments, there is a device for generating a building automation project of a building automation system, BAS, comprising an interface for receiving structural information regarding building equipment, and a computing unit. The computing unit generates a semantic model of the building automation system, comprising the step of automatically extracting equipment information from the structural information regarding the building equipment. The computing unit further extends the semantic model of the building automation system by providing application information. Further, the computing unit generates a building automation project, based on the equipment information and application information of the extended semantic model of the building automation system. The computing unit provides the generated building automation project to a building automation device via the interface.

In some embodiments, there is a computer program comprising executable program code configured to, when executed (e.g. by a computing device), perform one or more of the methods described herein.

In some embodiments, there is a non-transitory computer-readable data storage medium comprising executable program code configured to, when executed (e.g. by a computing device), perform one or more of the methods described herein.

As used in this disclosure, expressions like “generate” “extend”, “extract”, “compute”, “determine”, and the like, refer to methods, processes, and/or process steps that change, generate or transform data that is provided in a computer-readable form. Said methods, processes or process steps may be performed at least partially and/or completely automatically, i.e. by a computing unit.

In this disclosure, a “computing unit” may comprise any electronic device adapted to perform data processing methods, such as personal computers, server, handheld devices, mobile devices and other communication devices. The computing unit may comprise a plurality of single units, like hardware interfaces, communication controllers, processors and the like. The processing unit can comprise at least one of a central processing unit (CPU) or graphics processing unit (GPU), like a microcontroller (μC), an integrated circuit (IC), an application-specific integrated circuit (ASIC), an application-specific standard product (ASSP), a digital signal processor (DSP), a field programmable gate array (FPGA) and the like.

In this disclosure, a “database” may be any organized collection of data, stored on a memory and accessible by the computing unit. The computing unit may be adapted to retrieve data from the database and/or to modify entries in the database.

In this disclosure, a “memory” may be any volatile and/or non-volatile data memory, e.g. a solid-state disk, memory card, compact disc, and the like.

In this disclosure, an “interface” can be arranged as both an input unit and an output unit and may comprise any kind of port or link or interface capable of communicating information to another system, e.g. WLAN, Bluetooth, ZigBee, Profibus, ETHERNET etc.

In this disclosure, “computer-implemented method” can mean that at least one step of the method is performed by a computing unit.

In this disclosure, “building automation” may refer to an automatic and preferably centralized control of electronic and/or mechanical devices arranged in a building or facility.

In this disclosure, a “building automation system”, BAS, relates to a computer-based control system to be installed in a building or facility and being adapted to control mechanical and/or electrical equipment of the building or facility. The building automation system may comprise both hardware and software components. The software components may be configured in a hierarchical manner and may communicate via protocols, e.g. BACnet, or any other IP-based protocol, Profibus, Modbus, KNX, and the like.

In this disclosure, “building equipment” refers to electronic and mechanical devices to be controlled by the automation system and may comprise at least one of heating, ventilation and air conditioning, HVAC, equipment, security systems (such as closed-circuit television, CCTV, and motion detectors), fire alarm systems, lighting systems, access control, blinds, lifts, elevators, plumbing, disaster-response mechanisms, and the like.

In this disclosure, “structural information” may comprise any input data available during early phases of the automation process, e.g. during the planning stage.

In this disclosure, “equipment information” may comprise information regarding the number, type and connections of building equipment.

In this disclosure, “application information” may comprise information for controlling or operating building equipment. For example, application information may comprise instructions or routines to be processed by controller that control the building equipment.

In this disclosure, a “semantic model” or “semantic data model” may refer to a semantics-based database description and structuring formalism for databases. A semantic model may describe physical or abstract entities, in particular the building equipment, building structure and the applications. In addition, semantic information is assigned to the entities which provide a description or meaning of the entities. A semantic model may refer to a conceptual data model including such semantic information.

In this disclosure, an “extended semantic model” refers to an extension of the semantic model by providing additional data or information.

In this disclosure, a “building automation project” may refer to a program for configuring building equipment, applications and the like. A user may control the building automation project via a graphic user interface. The building automation project may further provide data such as functional specifications, bill of material, cost or information regarding the semantic model or extended semantic model.

In this disclosure, a “building automation device” may refer to any device comprising hardware and/or software components which presents the building automation project to a user. The building automation device may comprise a graphic user interface outputting data related to the building automation project to the user. The building automation device may further comprise an interface for receiving control signals from a user, e.g. a keyboard, mouse, touchscreen, buttons, switches and the like.

Various embodiments of the teachings herein include an automatic method for providing building automation projects. Required manual input by experts may be reduced as much as possible. Provided structural information may be automatically processed by modern data processing algorithms, e.g. computer vision methods, machine learning or data fusion, to generate a semantic model. The semantic model generated by such highly sophisticated methods and algorithms is further enhanced to provide both equipment information and application information. Based on the extended semantic model, the building automation project is automatically generated. A result is a much higher efficiency, and a big reduction in cost and engineering faults in building automation projects.

In some embodiments, the structural information regarding the building equipment comprises at least one of: an architectural drawing, a heating, ventilation and air conditioning, HVAC, schema, an electrical schema, technical drawings, and a functional specification.

The architectural drawings may describe building equipment and may in particular comprise the specific relative arrangement or topology of the building equipment layout (e.g. the floorplan) and of the building equipment.

In some embodiments, structural information from different data sources can be processed by the computing unit. For example, the structural data may be provided in different file formats, e.g. .pdf, .dwg, .xls, .doc, .txt formats and the like.

In some embodiments, the equipment information of the semantic model of the building automation system comprises at least one of: an architecture semantic model generated based on the architectural drawing, an HVAC semantic model generated based on the HVAC schema, and an electrical semantic model generated based on the electrical schema.

The semantic model of the building automation system may be divided into several semantic models. The respective semantic model may comprise semantic data describing the respective entities. For example, the architecture semantic model may comprise semantic information describing the type or specifications of the building equipment and the layout described by the architectural drawing. The HVAC semantic model may comprise semantic information describing the type or specifications of the HVAC components described by the HVAC schema. Further, the electrical semantic model may comprise semantic information describing the type or specifications of the electrical components described by the electrical schema. The semantic information may be determined based on an analysis of the respective structural information and may further be based on data stored in a database.

In some embodiments, automatically extracting equipment information from the structural information regarding the building equipment comprises at least one of applying computer vision methods to the structural information regarding the building equipment and applying data fusion methods to the structural information regarding the building equipment. According to some embodiments, the semantic model may also be generated based on machine learning procedures. Accordingly, the semantic model may be generated automatically with none or only minimal input required by experts.

In some embodiments, automatically extracting equipment information from the structural information regarding the building equipment comprises specifying a type of building equipment and/or relations of the building equipment. Together with the type of equipment, information regarding specifications of the equipment may be provided.

In some embodiments, providing application information comprises specifying a type of applications corresponding to the building equipment and/or relations between the applications corresponding to the building equipment. Examples for applications may comprise applications for operating controller for controlling the building equipment. The type of applications may refer to specific protocols or types of the respective controller. The type of application may be determined based on the type of the corresponding building equipment.

In some embodiments, extending the semantic model of the building automation system further includes selecting building equipment and/or controller from a database. Selecting the building equipment and/or controller may be based on information present in the semantic model, e.g. types, numbers and/or specifications of building equipment specified in the semantic model.

In some embodiments, the semantic model of the building automation system further includes counting data points based on the HVAC semantic model, wherein the building equipment and/or controller are selected based on the counted data points. Data points may correspond to specific sensors or actuators. To each data point, there can be assigned an IP address. The total number of data points may restrict the applicable controller and accordingly the possible applications.

In some embodiments, extending the semantic model of the building automation system further includes providing protocol type information, wherein the step of selecting building equipment and/or controller is based on the provided protocol type information. For example, different controller may only support specific protocol types. Depending on the protocol type information, a suitable controller is selected.

In some embodiments, extending the semantic model of the building automation system further includes providing a design network topology based on information stored in a database. The design network topology may describe the way the controller and building equipment are connected.

In some embodiments, generating the building automation project comprises providing at least one of: building structure information, network information, controller information, input/output module information, management station information, field device information, and application information. For example, the input/output module information may be determined based on the counted number of data points. The management station information may relate to information regarding a specific device that allows a facility manager to operate parameters of the building automation system, such as a personal computer or handheld device.

In some embodiments, the method further comprises the step of loading the generated building automation project on the building automation device and adjusting equipment and/or controller of the building automation system by the building automation device, using the generated building automation project. For example, specific control parameters may be adjusted based on information provided by the building automation project.

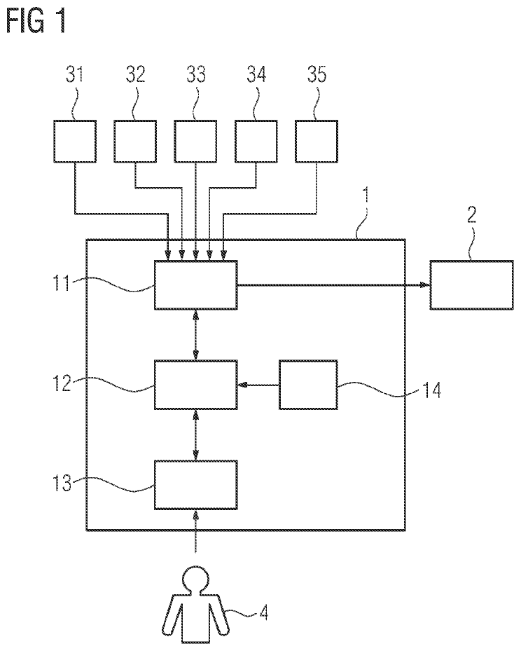

FIG. 1 shows a block diagram illustrating a device 1 for generating a building automation project of a building automation system incorporating teachings of the present disclosure. The device 1 comprises an interface 11 adapted to retrieve structural information. The interface 11 may communicate via any type of wireless communication or via electrical or optical means. The interface 11 may be connected to a central server for retrieving the structural information regarding building equipment to be controlled by a building automation system.

The structural information obtained via the interface 11 comprises an architectural drawing 31, a heating, ventilation and air conditioning, HVAC, schema 32, an electrical schema 33, technical drawings 34, and functional specifications 35. The structural information 31 to 35 may be at least partially provided in different file formats, comprising, e.g., .pdf, .dwg, .xls, .doc, .txt formats and the like. In some embodiments, the structural information 31 to 35 is converted to a uniform file format prior to providing the structural information to the interface 11 of the device 1.

The device 1 further comprises a computing unit 12 which is connected to the interface 11 and has access to a database 14 stored in a memory of the device 1. The computing unit 12 receives and further processes the structural information retrieved by the interface 11. The computing unit 12 generates a semantic model of the building automation system by extracting equipment information from the structural information regarding the building equipment.

The semantic model may comprise an architecture semantic model, an HVAC semantic model, and an electrical semantic model. Generating the semantic model may comprise the application of computer vision methods to the structural information provided to the device 1 via the interface 11. Further, data fusion methods or machine learning methods may be applied to the structural information regarding the building equipment by the computing unit 12. Extracting equipment information from the structural information may further comprise the specification of a type of the building equipment and/or the specification of relations of the building equipment among each other.

The computing unit 12 is further adapted to extend the generated semantic model of the building automation system by providing additional application information. Extending the semantic model may comprise specifying a type of applications corresponding to building equipment, e.g., for controlling building equipment. The applications may be loaded onto control devices for controlling the building equipment. Providing application information may further comprise specifying relations between the applications corresponding to the building equipment. Accordingly, application information may specify the interplay or interoperability of different control devices or control system components or subroutines.

The computing unit 12 further extends the semantic model of the building automation system by selecting building equipment, e.g. field devices, and/or controller specified in a database 14 of said device 1 for generating a building automation project. The computing unit 12 may further be adapted to extend the semantic model of the building automation system by counting data points based on the HVAC semantic model. In particular, the computing unit 12 may determine the building equipment and/or controller to be selected based on the counted data points. For instance, the database 14 may comprise relations between data points and respective building equipment and/or controller. Based on these relations, the computing units 12 selects suitable building equipment and/or controller.

The computing unit 12 may further extend the semantic model of the building automation system by including protocol type information. The building equipment and/or controller may be based on the provided protocol type information. Generally, each controller or field device may be adapted to interact according to one or more specific protocol types. The computing unit 12 may further extend the semantic model of the building automation system by providing a design network topology based on information stored in the database 14.

Further, the computing unit 12 generates a building automation project based on the equipment information and application information implemented in the extended semantic model of the building automation system. The computing unit 12 may provide building structure information of the building automation system, e.g., types and specifications of building equipment. The building automation project may further include network information, controller information, input/output module information, management station information, field device information, and/or application information.

The computing unit 12 can provide the generated building automation project to an external building automation device 2 via the interface 11. In some embodiments, the device 1 may also be part of the building automation device 2. The building automation device 2 may be adapted to adjust parameters of building equipment and/or of controller of the building.

The device 1 further comprises a user interface 13 for retrieving control signals from a user 4. The user 4 may provide additional information. For example, the user may provide an IP address range, protocol type, dimensioning data (e.g. the size of valves, pipes, and the like), equipment type or project info. In particular, for some projects, additional input from a user 4 may be required to provide the extended semantic model. Accordingly, the user 4 may provide additional labels via the user interface 13. For example, the structural information may comprise unknown symbols or labels which cannot be automatically analyzed by the computing unit 12. The user 4 may manually provide this additional data.

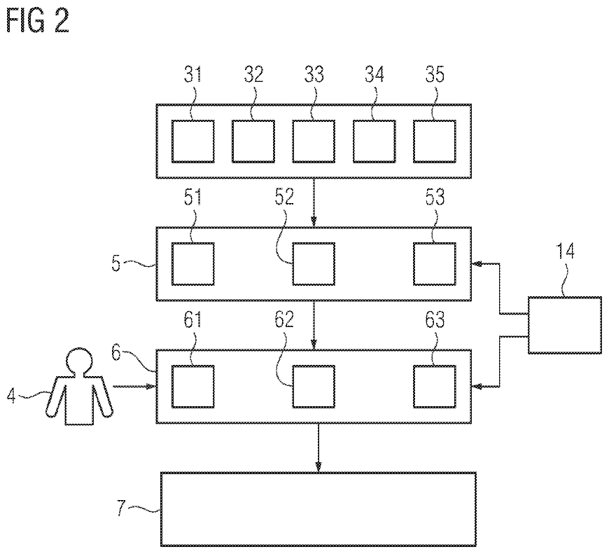

FIG. 2 shows a block diagram illustrating the generation of the building automation project incorporating teachings of the present disclosure. Structural information, including an architectural drawing 31, a HVAC schema 32, an electrical schema 33, technical drawings 34, and a functional specification 35 is automatically processed in order to determine a semantic model 5, comprising an architecture semantic model 51, an HVAC semantic model 52, and an electrical semantic model 53. The semantic model 5 is further enhanced to provide an extended semantic model 6, comprising an extended architecture semantic model 61, and extended HVAC semantic model 62, and an extended electrical semantic model 63. For providing the extended electrical semantic model 63, a user 4 may provide additional data, such as missing labels or semantic information. Further, for providing the semantic model 5, including equipment information, and the extended semantic model 6, including application information, data provided in a database 14 stored in a memory can be used. The data provided in the database may comprise lookup tables which provide semantic labels for specific identified building equipment. Based on the extended semantic model 6, a building automation project 7 is generated by the computing unit 12.

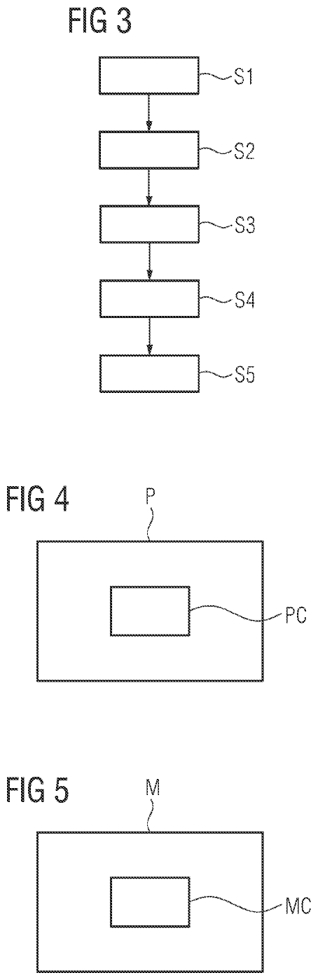

FIG. 3 shows a flow diagram of a computer-implemented method for generating a building automation project of a building automation system incorporating teachings of the present disclosure. In a first step S1, structural information regarding a building is provided via an interface 11. As described above, the structural information may comprise an architectural drawing 31, a HVAC schema 32, an electrical schema 33, technical drawings 34, and functional specifications 35.

In a second step S2, a semantic model 5 of the building automation system is automatically generated, comprising the equipment information extracted from the structural information. The semantic model 5 may comprise several sub-models, such as an architecture semantic model 51, an HVAC semantic model 52, and an electrical semantic model 53. For extracting the equipment information, at least one of computer vision methods, data fusion methods and machine learning methods may be applied. In particular, types, numbers and specifications of equipment building may be automatically extracted from the structural information.

In a third step S3, the semantic model 5 is extended by providing application information. The type of applications corresponding to the building equipment and/or relations between the applications corresponding to the building equipment may be determined. Further, building devices and/or controller of the building automation system may be selected from a database 14. Further, data points may be counted based on the HVAC semantic model and the building equipment and/or controller may be selected based on the counted data points. Further, protocol type information may be provided, and the building equipment and/or controller are selected based on the provided protocol type information.

In a fourth step S4, a building automation project is generated based on the equipment information and the application information of the extended semantic model.

In a fifth step S5, the generated building automation project 7 is loaded on a building automation device 2. Building equipment and/or controller may be adjusted or controlled by the building automation device 2 based on the building automation project 7.

FIG. 4 illustrates a block diagram illustrating a computer program product P comprising executable program code PC incorporating teachings of the present disclosure. The executable program code PC is configured to perform, when executed (e.g. by a computing unit 12), one or more of the methods described herein.

FIG. 5 schematically illustrates a block diagram illustrating a non-transitory, computer-readable storage medium M comprising executable program code MC configured to, when executed (e.g. by a computing device), perform one or more of the methods described herein.

It should be understood that all advantageous options, variance in modifications described herein and the foregoing with respect to embodiments of the methods described herein may be equally applied to embodiments of the devices, and vice versa. In the foregoing detailed description, various features are grouped together in one or more examples for the purpose of streamlining the disclosure. It is to be understood that the above description is intended to be illustrative, and not restrictive.

It is intended to cover alternatives, modifications and equivalents. Many other examples will be apparent to one skilled in the art upon reviewing the above specification.

### LIST OF REFERENCE SIGNS

1 device for generating a building automation project
2 building automation device
4 user
5 semantic model
6 extended semantic model
7 building automation project
11 interface
12 computing unit
13 user interface
14 database
31 architecture schema
32 HVAC schema
33 electrical schema
34 technical drawing
35 tender text
51 architecture semantic model
52 HVAC semantic model
53 electrical semantic model
61 extended architecture semantic model
62 extended HVAC semantic model
63 extended electrical semantic model
M storage medium
MC program code
P computer program product
PC program code
S1 first method step
S2 second method step
S3 third method step
S4 fourth method step
S5 fifth method step

What is claimed is:

1. A computer-implemented method for generating a building automation project of a building automation system, BAS, the method comprising:
receiving via an interface structural information regarding building equipment;
generating a semantic model of the building automation system, including automatically extracting equipment information from the structural information regarding the building equipment;
extending the semantic model of the building automation system by providing application information; and
generating, based on the equipment information and application information of the extended semantic model, a building automation project adapted for loading on a building automation device.

2. The method according to claim 1, wherein the structural information regarding building equipment comprises at least one item selected from the group consisting of:
an architectural drawing,
a heating, ventilation, and air conditioning (HVAC) schema,
an electrical schema,
technical drawings, and
a functional specification.

3. The method according to claim 2, wherein the equipment information of the semantic model of the building automation system comprises at least one model selected from the group consisting of:
an architecture semantic model generated based on the architectural drawing,
an HVAC semantic model generated based on the HVAC schema, and
an electrical semantic model generated based on the electrical schema.

4. The method according to claim 1, wherein automatically extracting equipment information from the structural information regarding the building equipment comprises at least one process selected from the group consisting of: applying computer vision methods to the structural information regarding the building equipment and applying data fusion methods to the structural information regarding the building equipment.

5. The method according to claim 1, wherein automatically extracting equipment information from the structural information regarding the building equipment comprises specifying a type of building equipment and/or relations of the building equipment.

6. The method according to claim 5, wherein providing application information comprises specifying a type of applications corresponding to the building equipment and/or relations of the building equipment.

7. The method according to claim 1, wherein extending the semantic model of the building automation system includes selecting building equipment and/or controller from a database.

8. The method according to claim 7, wherein:
extending the semantic model of the building automation system includes counting data points based on an HVAC semantic model generated based on an HVAC schema; and
the building equipment and/or controller are selected based on the counted data points.

9. The method according to claim 1, wherein:
extending the semantic model of the building automation system further includes providing protocol type information; and
selecting building equipment and/or controller is based on the provided protocol type information.

10. The method according to claim 1, wherein extending the semantic model of the building automation system includes providing a design network topology based on information stored in a database.

11. The method according to claim 1, wherein generating the building automation project comprises providing at least one information selected from the group consisting of:
building structure information,
network information,
controller information,
input/output module information,
management station information,
field device information, and
application information.

12. The method according to claim 1, further comprising:
loading the generated building automation project on the building automation device; and
adjusting building equipment and/or a controller by the building automation device using the generated building automation project.

13. A device for generating a building automation project of a building automation system, the device comprising:
an interface adapted to receive structural information regarding building equipment; and
a computing unit programmed:
to generate a semantic model of the building automation system, including automatically extracting equipment information from the structural information regarding the building equipment;
to extend the semantic model of the building automation system by providing application information; and
to generate, based on the equipment information and application information of the extended semantic model of the building automation system, a building automation project;
wherein the computing unit is further programmed to provide the generated building automation project to a building automation device via the interface.

14-15. (canceled)
